(19) United States
(12) Patent Application Publication
(10) Pub. No.: US 2026/0166608 A1
(43) Pub. Date: Jun. 18, 2026

(54) TENSION CONTROL APPARATUS

(71) Applicant: TOSHIBA MITSUBISHI-ELECTRIC INDUSTRIAL SYSTEMS CORPORATION, Tokyo (JP)

(72) Inventor: Ryo OGAWA, Tokyo (JP)

(73) Assignee: TOSHIBA MITSUBISHI-ELECTRIC INDUSTRIAL SYSTEMS CORPORATION, Tokyo (JP)

(21) Appl. No.: 18/711,359

(22) PCT Filed: Nov. 17, 2022
(86) PCT No.: PCT/JP2022/042740

§ 371 Date: May 17, 2024

(51) Int. Cl. B21B 3/00; B21B 37/16; B21B 37/52; B21B 38/02; B60W 30/14; B65B 11/02; B65B 13/02; B65H 57/16

(52) U.S. Cl. CPC B21B 3/00; B21B 37/16; B21B 37/52; B21B 38/02; B60W 30/146; B65B 11/025; B65B 13/027; B65H 57/16

(57) ABSTRACT

A tension control apparatus controls tension of the material to be rolled when the material to be rolled passed through the final rolling stand of the finishing mill is coiled on a mandrel through pinch rolls. The tension control apparatus is configured to switch rotational driving of the mandrel between speed control and current control. The tension control apparatus includes a selection unit configured to compare torque necessary for the speed control and torque necessary for the current control, and to select small torque as final torque, and an integrator configured to integrate an output of the speed control, and further includes a limit setting unit configured to set, to the integrator, a limit corresponding to a tension reference. The tension control apparatus is configured to prevent an output of the integrator from being saturated.

### TECHNICAL FIELD

The present disclosure relates to a tension control apparatus that controls tension of a material to be rolled when the material to be rolled passed through a final rolling stand of a finishing mill is coiled on a mandrel through pinch rolls.

### BACKGROUND ART

For example, a hot rolling plant includes a finishing mill including a plurality of rolling stands, and a coiler including pinch rolls and a mandrel. A strip that is a material to be rolled rolled by the finishing mill is coiled on the mandrel through the pinch rolls. For rotational driving of the pinch rolls and the mandrel, speed control (hereinafter, referred to as “tension control”) and current control are used.

In an existing other tension control apparatus disclosed in PTL 1 described below, the pinch rolls and the mandrel are driven under the speed control until a head end of the strip as the material to be rolled reaches the mandrel. After the head end of the strip reaches the mandrel, the driving of the pinch rolls and the mandrel is switched from the speed control to the tension control (current control). When a tail end of the strip passes through a final rolling stand of the finishing mill, driving of the mandrel is switched from the tension control (current control) to the speed control, thereby preventing rapid increase of the speed of the strip.

The speed control and the tension control of the mandrel are performed based on signals transmitted from a host computer (hereinafter, also referred to as “master”) such as a PLC (Programmable Logic Controller) to a tension control apparatus. The signals include mater tension setting B_ST, speed reference SP_REF, and tension reference TENS_REF exemplified in FIG. 6 and FIG. 7. The master tension setting B_ST is a bit signal switching on/off of the tension control. The speed reference SP_REF is a set speed of the mandrel, and is set to a value greater than a speed result SP-FBK. When the master tension setting B_ST is turned on, torque necessary for the speed control (speed control torque reference) input from a comparator 110 and the tension reference TENS_REF that is torque necessary for the tension control are compared by a selection unit MIN illustrated in FIG. 6, and smaller torque is selected as output torque.

To secure tension of the strip, it is necessary to set the speed reference SP_REF to a value greater than the speed result SP-FBK. Therefore, integration by an integrator 112 illustrated in FIG. 7 is performed up to a motor torque limit value set as an internal parameter. As a result, an I component (integral component) is increased to the motor torque limit value and is saturated.

### CITATION LIST

### Patent Literature

[PTL 1] JP H7-75824 A

### SUMMARY OF THE INVENTION

### Problems to be Solved by the Invention

However, in the above-described existing example, when the material to be rolled passes through the final rolling stand, the pinch rolls are subjected to the speed control, whereas the mandrel is subjected to the current control. Therefore, the speed of the material to be rolled is rapidly increased by slip of the pinch rolls generated, in particular, in a case where pressing force of the pinch rolls to the material to be rolled is weak or in a case where tension setting of the mandrel is large. Further, when a speed control integrator integrating a speed output is saturated and the speed result SP_FBK is lower than the speed reference SP_REF, the speed of the material to be rolled is controlled in a deceleration direction for the first time. As a result, as illustrated in a part surrounded by an alternate long and two short dashes line in FIG. 8, a material speed is largely overshot. The speed control cannot be performed while the material speed is overshot. This may lead to deterioration in accuracy of a stop position of a tail end of the coiled material to be rolled, and depending on a case, it is necessary to coil the material to be rolled again.

The present disclosure has been made to solve the above-described issues, and an object of the present disclosure is to provide a tension control apparatus that can improve accuracy of the stop position of the tail end of the coiled material to be rolled, by suppressing speed overshoot of the material to be rolled after the material to be rolled passes through the final rolling stand of the finishing mill.

### Solution to Problem

The present disclosure relates to a tension control apparatus controlling tension of a material to be rolled when the material to be rolled passed through a final rolling stand of a finishing mill is coiled on a mandrel through pinch rolls. The tension control apparatus being configured to switch rotational driving of the mandrel between speed control and current control. The tension control apparatus comprises a selection unit and an integrator. The selection unit is configured to compare torque necessary for the speed control and torque necessary for the current control, and to select small torque as final torque. The integrator is configured to integrate an output of the speed control. The tension control apparatus further comprises a limit setting unit configured to set, to the integrator, a limit corresponding to a tension reference. The tension control apparatus is configured to prevent an output of the integrator from being saturated.

### Advantageous Effects of the Invention

According to the present disclosure, the limit is set to the integrator integrating the output of the speed control. As a result, before the output of the integrator is saturated, the torque necessary for the speed control is selected by the selection unit. Thus, the speed overshoot of the material to be rolled after the material to be rolled passes through the final rolling stand of the finishing mill is suppressed. In other words, after the tail end of the material to be rolled passes through the final rolling stand, following capability of the speed of the material to be rolled, to the speed reference is enhanced. Accordingly, it is possible to accurately stop the tail end of the material to be rolled coiled on the mandrel.

### BRIEF DESCRIPTION OF DRAWINGS

FIG. 1 is a schematic view illustrating a configuration of a rolling plant to which a tension control apparatus according to an embodiment is applied.

FIG. 2 is a block diagram schematically illustrating a function of the tension control apparatus according to the embodiment.

FIG. 3 is a time chart to explain speed control in the embodiment.

FIG. 4(a) is a graph showing speed result against speed reference in the embodiment, and FIG. 4(b) is a graph showing speed result against speed reference in an existing example.

FIG. 5 is a diagram illustrating an example of a hardware configuration of a processing circuit held by the tension control apparatus.

FIG. 6 is a diagram illustrating an example of a hardware configuration of a processing circuit held by the tension control apparatus.

FIG. 7 s a block diagram schematically illustrating a function of the tension control apparatus according to the existing example.

FIG. 8 is a time chart to explain speed control in the existing example.

### DESCRIPTION OF EMBODIMENT

An embodiment of the present invention is described in detail below with reference to drawings. Note that elements common to the drawings are denoted by the same reference numerals, and repetitive description is omitted.

### Rolling Plant

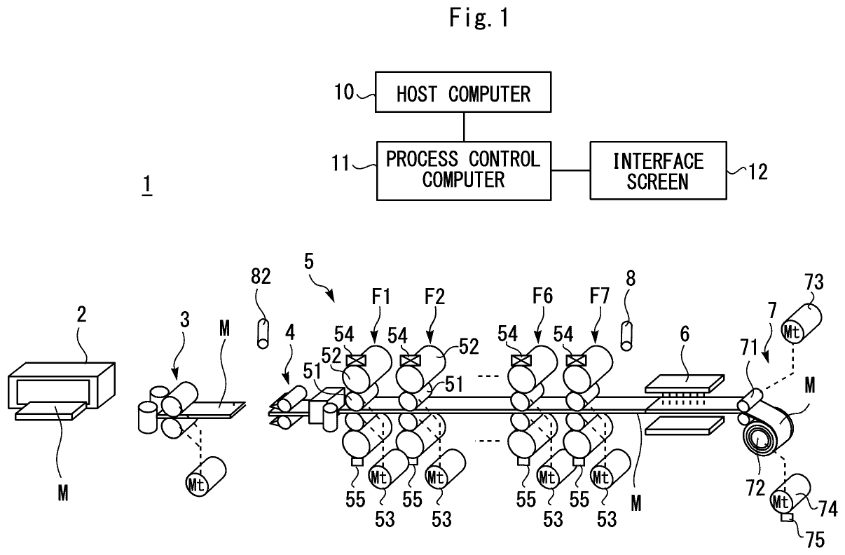

FIG. 1 is a schematic view illustrating a configuration of a rolling plant 1 to which a rolling risk presentation apparatus according to the present disclosure is applied. The rolling plant 1 uses a slab and a strip made of steel or other metal material as a material to be rolled M, and hot-rolls the material to be rolled M into a plate shape.

In the rolling plant 1, a heating furnace 2, a roughing mill 3, a crop shear 4, a finishing mill 5, a cooling apparatus 6, and a coiler 7 are installed as main facilities.

The heating furnace 2 heats a rectangular-parallelepiped slab as the material to be rolled M before rolling, to a predetermined temperature (for example, 1200° C.). The roughing mill 3 includes at least one rolling stand, normally one to three rolling stands, and performs multi-pass rolling on the material to be rolled M heated by the heating furnace 2 in a forward direction (from upstream to downstream of rolling line) and in a reverse direction (from downstream to upstream of rolling line). The crop shear 4 cuts a defective shape portion present at a head end portion or a tail end portion of the material to be rolled M by upper and lower blades.

The finishing mill 5 is a tandem rolling mill including N rolling stands Fi (1≤i≤N) arranged side by side in a conveyance direction of the material to be rolled M. In the present embodiment, a case where seven rolling stands F1 to F7 are arranged side by side, and a final rolling stand is the rolling stand F7 is described. Each of the rolling stands F1 to F7 includes two upper and lower work rolls 51, two upper and lower backup rolls 52, and an electric motor 53 for roll rotational driving. Reduction apparatuses 54 are provided on the backup rolls 52, and each of the reduction apparatuses 54 can adjust a gap between the corresponding upper and lower work rolls 51 (hereinafter, simply abbreviated as “gap”). Roll force of the rolling stands F1 to F7 are measured by respective roll force sensors 55. The cooling apparatus 6 is configured to cool the material to be rolled M by pouring water to the material to be rolled M by a cooling bank. The cooled material to be rolled M is coiled into a coil shape by the coiler 7.

The coiler 7 includes one pair or a plurality of pairs (in present embodiment, one pair) of pinch rolls 71, one or a plurality of (in present embodiment, one) mandrel 72, an electric motor 73 for pinch roll rotational driving, an electric motor 74 for mandrel rotational driving, and a pulse generator (PLG) 75. Note that a coiling guide (not illustrated) guiding the material to be rolled M to the pinch rolls 71 and the mandrel 72 may be disposed.

Various kinds of sensors as measuring equipment are installed at key points of the rolling plant 1. The various kinds of sensors include the above-described roll force sensors 55, the pulse generator (PLG) 75, an end portion detection sensor 8 detecting a head end or a tail end of the material to be rolled M on a delivery side of the final rolling stand F7, and the like. The various kinds of sensors successively measure states of the material to be rolled M and the corresponding apparatuses.

The rolling plant 1 is operated by a control system using computers. The computers include a host computer 10 and a process control computer 11 that are connected to each other through a network. The host computer 10 is, for example, a PLC (Programmable Logic Controller). An interface screen 12 that is a screen operated by an operator is connected to the process control computer 11 through the network.

The process control computer 11 performs setting calculation/control of a control object in a series of rolling processes. The process control computer 11 receives, from the host computer 10, slab information such as a thickness, a width, a length, and a steel grade of the slab as the material to be rolled M before rolling, coil target information such as a target thickness, a target width, and a target temperature of the strip as the material to be rolled M after rolling, rolling setup information such as gaps in the respective rolling stands F1 to F7 of the finishing mill 5, and the like.

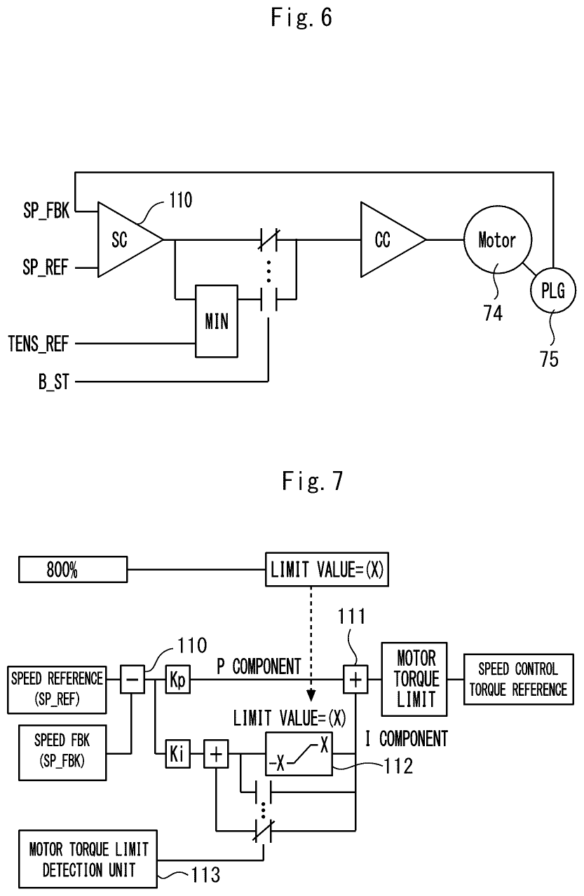

In the present embodiment, the process control computer 11 has a function of controlling tension of the material to be rolled M coiled on the mandrel 72. In other words, the process control computer 11 can also function as a tension control apparatus. The tension control apparatus 11 has a function as a driver (amplifier) controlling the electric motor (motor) 74. Although not illustrated, the tension control apparatus 11 includes a selection unit MIN illustrated in FIG. 6.

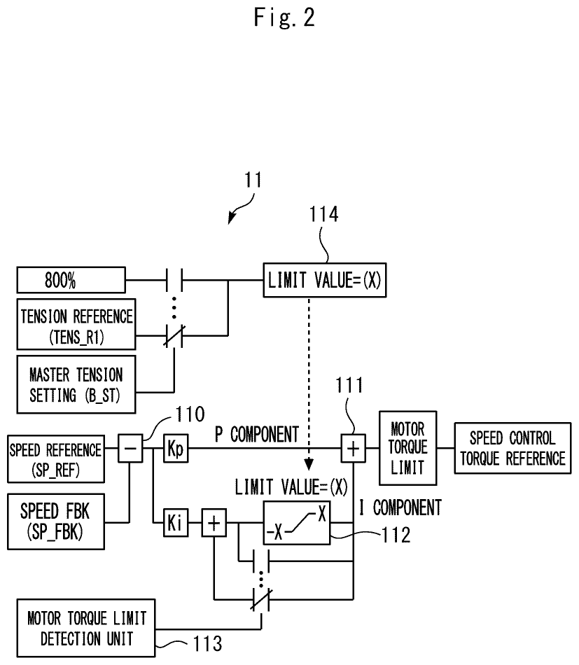

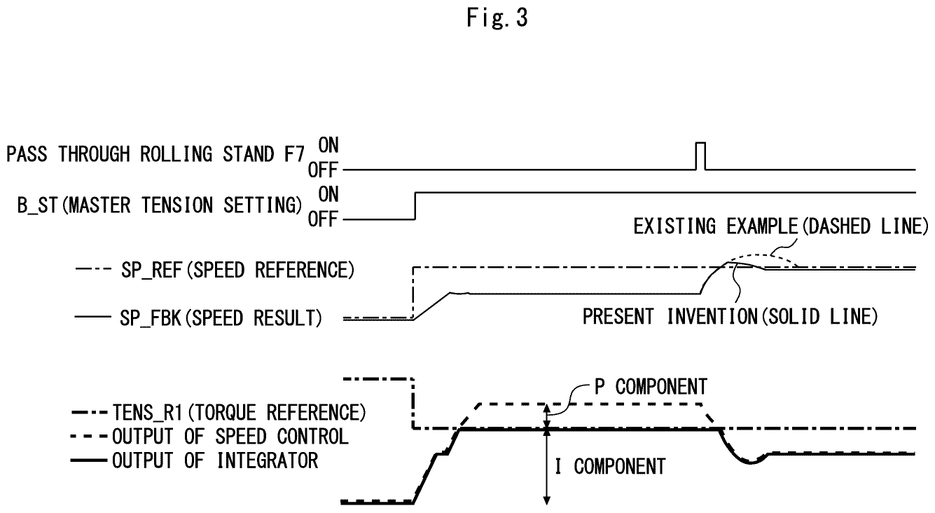

FIG. 2 is a block diagram schematically illustrating a configuration of the tension control apparatus 11. FIG. 3 is a time chart to explain speed control by the tension control apparatus 11.

The tension control apparatus 11 receives coiling information as information about coiling, from the host computer 10. Examples of the coiling information includes master tension setting B_ST, speed reference SP_REF, and tension reference TENS_REF. The master tension setting B_ST is a bit signal switching on/off of the tension control. The speed reference SP_REF is a set speed of the speed control. The tension reference TENS_REF is a master torque reference.

The master tension setting B_ST input from the host computer 10 to the tension control apparatus 11 is turned on, and the speed reference SP_REF is input from the host computer 10 to the tension control apparatus 11. At this time, a value of the speed reference SP_REF is set to be greater than a value of a speed result SP_FBK fed back from the PLG 75. This makes torque necessary for the speed control (speed control torque reference) greater than the tension reference TENS_REF that is torque necessary for the tension control. Further, the speed reference SP_REF and the speed result SP_FBK are compared by a comparator 110, and a difference therebetween is determined. An adder 111 adds a P component (proportional component) obtained by multiplying the difference output from the comparator 110 by a predetermined coefficient (proportional gain) Kp, and an I component (integral component) obtained by integrating, by an integrator 112, a value obtained by multiplying the difference by a predetermined coefficient Ki. Note that 800% in FIG. 2 is a maximum limit value set in the rolling plant 1. The integration by the integrator 112 is performed until a preset motor torque limit is detected by a motor torque limit detection unit 113.

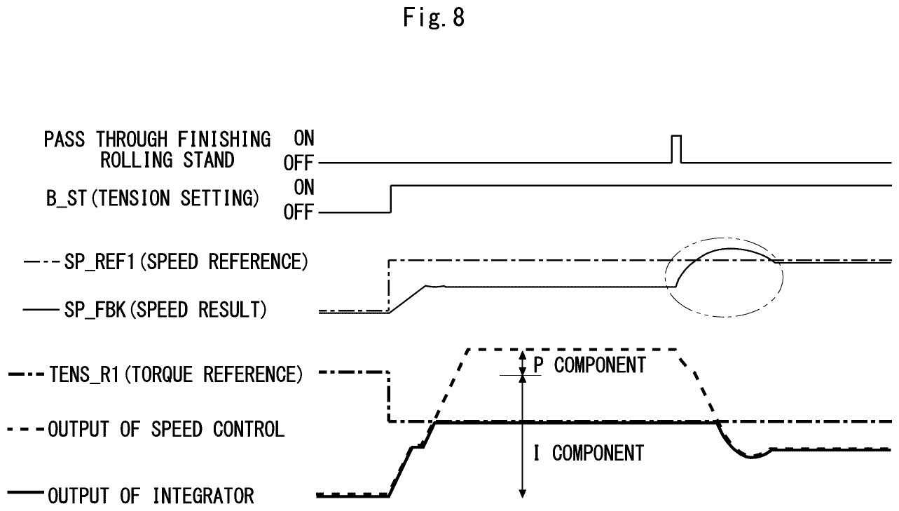

The tension control apparatus 11 further includes a limit setting unit 114. The limit setting unit 114 sets a limit value corresponding to the tension reference (torque reference) TENS_REF to the integrator 112 when the master tension setting B_ST is turned on. As a result, the I component integrated by the integrator 112 reaches a celling at the tension reference (master torque reference) TENS_REF. In other words, the I component of the integrator 112 is limited before being saturated. In contrast, in the existing example illustrated in FIG. 8, the I component of the integrator 112 is saturated beyond the tension reference (master torque reference) TENS_REF.

Thereafter, when the tail end of the material to be rolled M passes through the final rolling stand F7, the speed result SP_FBK that is constant until that time is increased. At this time, since the I component is suppressed as described above, the overshoot of the speed result SP_FBK is small as compared with the existing example. Therefore, a time until a suppression drive final output becomes lower than the tension reference (torque reference) TENS_REF is reduced as compared with the existing example. As a result, the control can be switched from the tension control to the speed control in a short time after the tail end of the material to be rolled M passes through the final rolling stand F7.

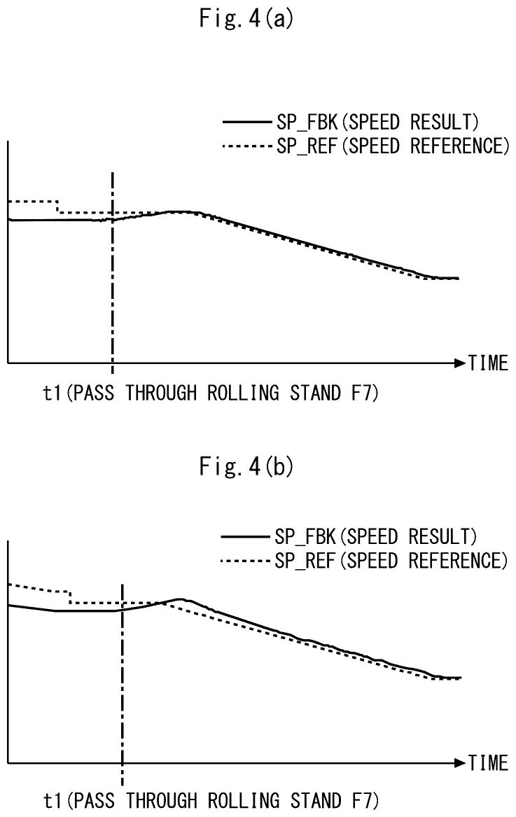

As described above, according to the present embodiment, the limit corresponding to the tension reference (torque reference) TENS_REF is set to the integrator 112 integrating the output of the speed control, and the torque necessary for the speed control is accordingly selected by the selection unit MIN before the output of the integrator 112 is saturated. Thus, as illustrated in FIG. 4(a), after time t1 when the material to be rolled M passes through the final rolling stand F7 of the finishing mill 5, the speed overshoot of the material to be rolled M is suppressed as compared with the existing example (see FIG. 4(b)). As a result, it was confirmed that, after the time t1, following capability of the speed result SP_FBK of the material to be rolled M measured by the PLG 75, to the speed reference SP_REF can be enhanced. Accordingly, it is possible to accurately stop the tail end of the material to be rolled coiled on the mandrel.

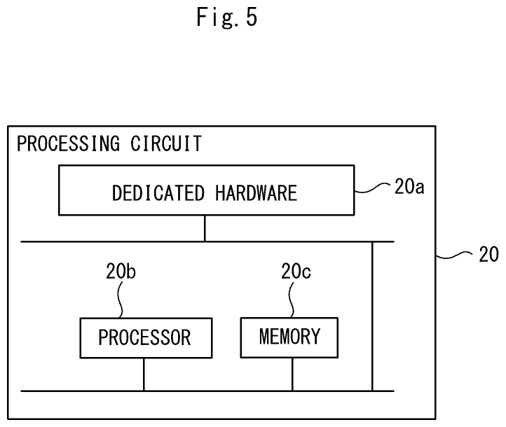

Note that a specific structure of the above-described tension control apparatus 11 is not limited; however, the following structure may be adopted as an example. FIG. 5 is a diagram illustrating an example of a hardware configuration of a processing circuit 20 held by the tension control apparatus 11. The functions of the tension control apparatus 11 can be realized by the processing circuit 20 illustrated in FIG. 5. The processing circuit 20 may be dedicated hardware 20a. The processing circuit 20 may include a processor 20b and a memory 20c. The processing circuit 20 may be partially formed as the dedicated hardware 20a, and may further include the processor 20b and the memory 20c. In the example in FIG. 5, a part of the processing circuit 20 is formed as the dedicated hardware 20a, and the processing circuit 20 also includes the processor 20b and the memory 20c.

At least a part of the processing circuit 20 may be at least one piece of dedicated hardware 20a. In this case, the processing circuit corresponds to, for example, a single circuit, a composite circuit, a programmed processor, a parallel-programmed processor, an ASIC, a FPGA, or a combination thereof.

The processing circuit 20 may include at least one processor 20b and at least one memory 20c. In this case, each of the functions of the tension control apparatus 11 is realized by software, firmware, or a combination of the software and the firmware. The software and the firmware are described as programs and stored in the memory 20c. The processor 20b realizes the functions of the respective units by reading out and executing the programs stored in the memory 20c.

The processor 20b is also called a CPU (Central Processing Unit), a central processing apparatus, a processing apparatus, a calculation apparatus, a microprocessor, a microcomputer, or a DSP. The memory 20c corresponds to, for example, a nonvolatile or volatile semiconductor memory such as a RAM, a ROM, a flash memory, an EPROM, and an EEPROM. As described above, the processing circuit 20 can realize the functions of the tension control apparatus 11 by the hardware, the software, the firmware, or the combination thereof.

Although the embodiment of the present invention is described above, the present invention is not limited to the above-described embodiment, and can be variously modified and implemented without departing from the spirit of the present invention. The configuration of the rolling plant is not limited to the example illustrated in FIG. 1, and the present invention can be applied to a rolling plant having variously modified configurations. Further, when numerals of the number, the quantity, the amount, the range, and the like of each of the elements are mentioned in the above-described embodiment, the present invention is not limited to the mentioned numerals except for the case of being particularly clearly mentioned and the case of being obviously specified to the numerals in principle. For example, the coiler 7 may include two or three pairs of pinch rolls 71 and two or three mandrels 72. Further, the structure and the like described in the above-described embodiment are not necessarily essential for the present invention except for the case of being particularly clearly mentioned and the case of being obviously specified to the structure and the like in principle.

### REFERENCE SIGNS LIST

1 . . . rolling plant, M . . . material to be rolled, MIN . . . selection unit, 11 . . . tension control apparatus, 112 . . . integrator, 114 . . . limit setting unit, 71 . . . pinch rolls, 72 . . . mandrel

1. A tension control apparatus controlling tension of a material to be rolled when the material to be rolled passed through a final rolling stand of a finishing mill is coiled on a mandrel through pinch rolls, the tension control apparatus being configured to switch rotational driving of the mandrel between speed control and current control, the tension control apparatus comprising:
a selection unit configured to compare torque necessary for the speed control and torque necessary for the current control, and to select small torque as final torque; and
an integrator configured to integrate an output of the speed control, the tension control apparatus further comprising
a limit setting unit configured to set, to the integrator, a limit corresponding to a tension reference, wherein the tension control apparatus is configured to prevent an output of the integrator from being saturated.

2. A tension control apparatus controlling tension of a material to be rolled when the material to be rolled passed through a final rolling stand of a finishing mill is coiled on a mandrel through pinch rolls, the tension control apparatus comprising:
circuitry configured to
switch rotational driving of the mandrel between speed control and current control; and
compare torque necessary for the speed control and torque necessary for the current control, and to select small torque as final torque; the tension control apparatus further comprising an integrator configured to integrate an output of the speed control, the circuitry configured to
set, to the integrator, a limit corresponding to a tension reference, to prevent an output of the integrator from being saturated.
